(19) United States
(12) Patent Application Publication
(10) Pub. No.: US 2014/0060683 A1
(43) Pub. Date: Mar. 6, 2014

(54) Uniform Circumferential Distribution of Fluid in a Manifold

(71) Applicant: Mahesh Bathina, Bangalore (IN)

(72) Inventor: Mahesh Bathina, Bangalore (IN)

(73) Assignee: General Electric Company, Schenectady, NY (US)

(21) Appl. No.: 13/604,105

(22) Filed: Sep. 5, 2012

(51) Int. Cl. F16K 11/00

(52) U.S. Cl. 137/597; 137/1

(57) ABSTRACT

Circumferential fluid distribution in an annulus can be made more uniform with an annulus coupleable with a feed supply pipe, where the apparatus includes a plurality of inlets arrayed in the annulus and receives fluid from the feed supply pipe, and a plurality of outlets connected to the annulus and delivering fluid radially inward from the annulus. The inlets distribute fluid in the annulus to the outlets. The inlets and the outlets are configured such that a fluid static pressure in the annulus is substantially consistent.

### BACKGROUND OF THE INVENTION

The invention relates generally to circumferential distribution of fluid and, more particularly, to uniform circumferential distribution of fluid such as fuel in a manifold in a gas turbine application.

A common mechanism for injecting fluids to a specific location in many engineering applications is by means of a pipe by which the fluid is supplied connected to an annulus region, where the fluid is distributed downstream through a number of circumferentially arranged outlets. From computational fluid dynamics (CFD) analysis, it is observed that higher flow rates are seen through circumferential outlets located near the feed supply pipe as well as the far end from the feed pipe. Outlets near the feed pipe are inline to the main flow and therefore see a higher total pressure in those regions. After entering the annulus, part of the kinetic head converts to static head, and the static head keeps increasing until the farthest outlet as flow tends to stagnate in the annulus region.

When there are multiple outlets connected to an annulus, a mass flow rate through individual outlets can vary from that of average flow. In some engineering applications, however, uniform flow is desired through all the circumferentially arranged outlets. Pressure drop across each outlet determines the flow rate through each outlet. As the downstream pressure can be assumed to be the same for all outlets, the upstream pressure distribution inside the annulus determines the flow rates.

In a turbine combustor, uniform fuel flow rates across all fuel nozzles enable the nozzle to behave as per the intended purpose. With non-uniform distribution, the fuel nozzles risk higher emissions as well as increased flame holding potential and undesired temperature profiles at the exit of the transition piece.

### BRIEF DESCRIPTION OF THE INVENTION

In an exemplary embodiment, an apparatus for circumferential fluid distribution in an annulus is coupleable with a feed supply pipe and includes a plurality of inlets arrayed in the annulus and receiving fluid from the feed supply pipe, and a plurality of outlets connected to the annulus and delivering fluid radially inward from the annulus. The inlets distribute fluid in the annulus to the outlets. The inlets and the outlets are configured such that a fluid static pressure in the annulus is substantially consistent.

In another exemplary embodiment, an apparatus for circumferential flow distribution in an annulus is coupleable with a feed supply pipe and includes a plurality of inlets in the annulus and receiving flow from the feed supply pipe, and a plurality of outlets connected to the annulus and delivering the flow radially inward from the annulus. The inlets distribute fluid in the annulus to the outlets. The inlets may be circumferentially offset relative to the feed supply pipe such that a static pressure circumferentially around the annulus is substantially consistent. Scoops are positioned in the annulus adjacent the outlets.

In yet another exemplary embodiment, a method for circumferential distribution of fluid flow in an annulus includes the steps of configuring the inlets and the outlets such that a fluid static pressure circumferentially around the annulus is substantially consistent; receiving fluid from the feed supply pipe; and distributing the fluid to the outlets.

### BRIEF DESCRIPTION OF THE DRAWINGS

FIG. 1 is a schematic illustration of a gas turbine;

FIG. 2 is a sectional view showing a fuel manifold in an annulus;

FIG. 3 is a perspective view showing the use of scoops;

FIG. 4 shows an annulus with turbulators; and

FIG. 5 shows an annulus including scoops and turbulators.

### DETAILED DESCRIPTION OF THE INVENTION

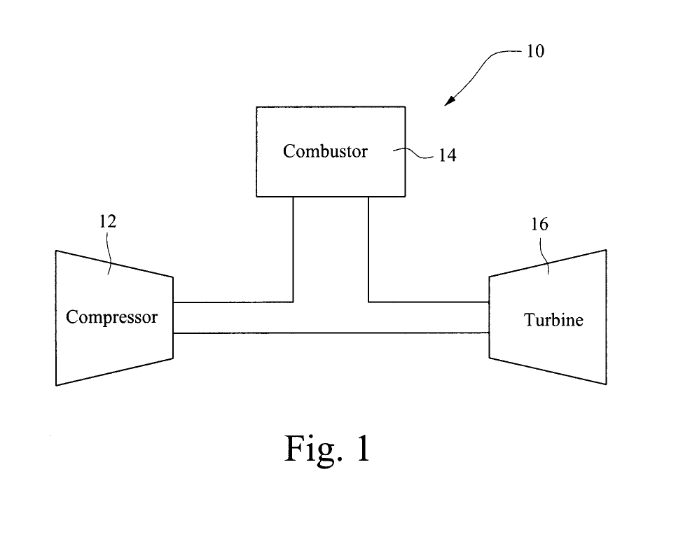

FIG. 1 illustrates a typical gas turbine 10. As shown, the gas turbine 10 generally includes a compressor at the front, one or more combustors 14 around the middle, and a turbine 16 at the rear. The compressor 12 and the turbine 16 typically share a common rotor. Typically, the compressor 12 pressurizes inlet air, which is then turned in direction or reverse flowed to the combustors 14 where it is used to cool the combustor and also to provide air to the combustion process. The combustors 14 inject fuel into the flow of compressed working fluid and ignite the mixture to produce combustion gases having a high temperature, pressure and velocity. The combustion gases exit the combustors 14 and flow to the turbine 16 where they expand to produce work.

A casing surrounds each combustor 14 to contain the compressed working fluid from the compressor 12. Nozzles are arranged in an end cover, for example, with outer nozzles radially arranged around a center nozzle. The compressed working fluid from the compressor 12 flows between the casing and a liner to the outer and center nozzles, which mix fuel with the compressed working fluid, and the mixture flows from the outer and center nozzles into upstream and downstream chambers where combustion occurs.

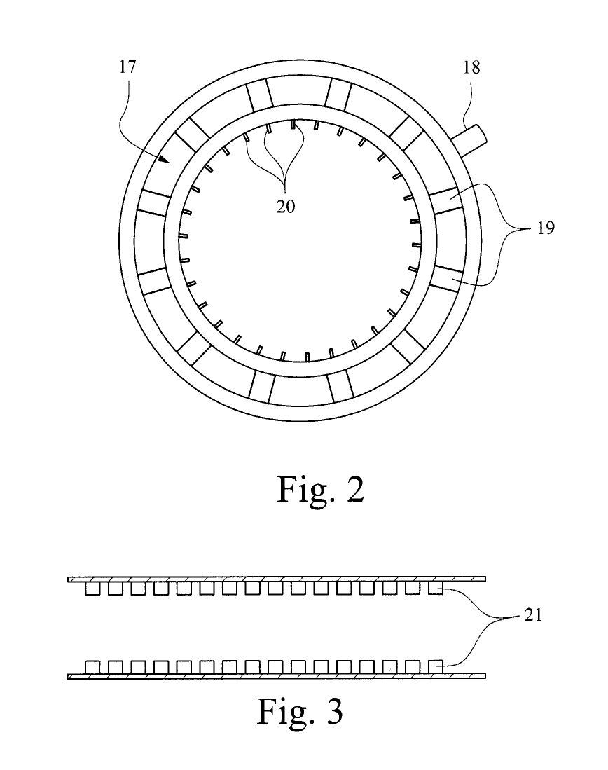

Fuel for combustion within a combustion zone of the turbine may be supplied by a pipe that is connected to an annulus region and then distributed downstream through a number of circumferentially arranged outlets. In many applications, uniform fuel flow is desired through the circumferentially arranged outlets. FIG. 2 is a sectional view showing an annulus 17 connected with a feed supply pipe 18. A plurality of inlets 19 are arrayed in the annulus 17 and receive and distribute fuel from the feed supply pipe 18. A plurality of outlets 20 are connected to the annulus and deliver fuel radially inward from the annulus 17. The inlets 19 and the outlets 20 are preferably configured such that a fuel static pressure in the annulus 17 is substantially consistent. In the arrangement shown in FIG. 2, this is achieved with the inlets 19 circumferentially offset relative to the feed supply pipe 18. In contrast with existing multiple inlet manifolds, it has been discovered that a mass flow rate through the outlets 20 can be made considerably more uniform with the offset arrangement shown in FIG. 2 as compared with single inlet manifolds or multiple inlet manifolds where an inlet is aligned with the feed supply pipe.

An additional or alternative structural feature to facilitate uniform fuel distribution is shown in FIG. 3. As shown, turbulators 21 may be positioned around the annulus and axially along the annulus to normalize a mass flow rate such that a maximum flow rate among the plurality of outlets defines a substantially linear profile. The linear profile helps in placement and sizing of the outlet holes to achieve a desired amount of fluid flow rate into the specific zones of the combustor. Turbulators in general have been used to enhance the heat transfer across a metal surface (see, e.g., U.S. Pat. No. 5,738,493). In the current application, turbulators 21 are used to make the pressure distribution inside the annulus vary gradually.

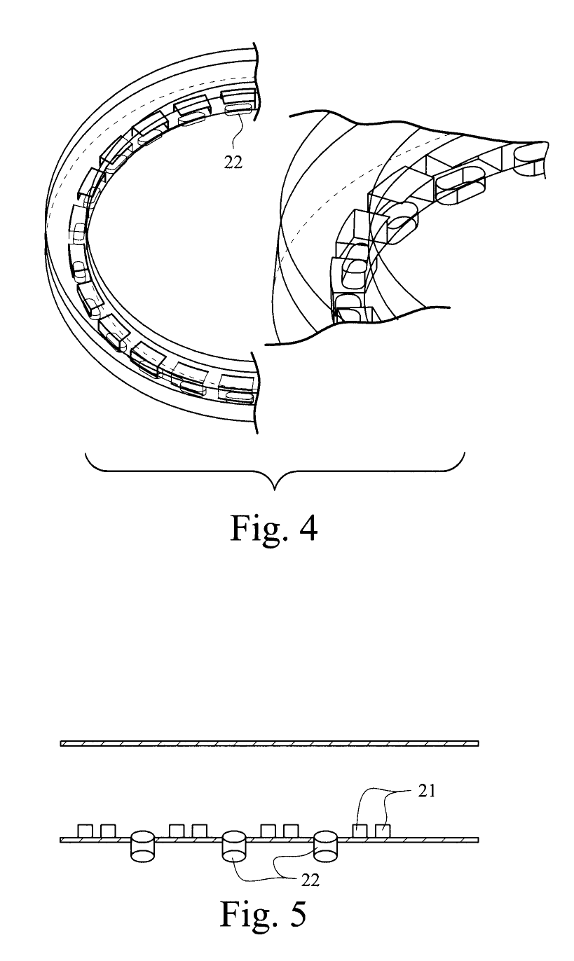

With reference to FIG. 4, the annulus may include scoops 22 positioned in the annulus adjacent the outlets. The term “scoop” refers to an enclosure, channel or trough that is open only on one side. The scoops 22 similarly reduce non-uniformities in circumferential flow distribution. A typical scoop can either fully or partially surround the outlets (for example, the scoop could be in the shape of a half cylinder with or without a top) or partially or fully cover the opening and be generally part-spherical in shape. Other shapes that provide a similar flow catching functionality may also be used. Within the framework of the invention, the open sides of the scoops 22 can be angled toward the direction of flow. The scoops 22 can be manufactured either singly, in a strip, or as a sheet with all scoops being fixed in a single operation.

In use, fluid is channeled by the scoops 22 that project out into the annulus and by a combination of stagnation and redirection, catch fluid that would previously have passed the outlets due to the lack of static pressure differential to drive the flow through them.

With a known flow rate through the outlets 20, the scoops 22 can be preferentially placed to control a fluid static pressure at respective outlets in the annulus such that the static pressure drop and thus the flow rates are substantially consistent among the outlets. Computational simulations may be carried out to demonstrate the effect of scoops. Additionally or alternatively, a depth of the scoops may be varied similarly to control fluid flow.

FIG. 5 shows an exemplary embodiment utilizing turbulators 21 and scoops 22, where the turbulators 21 are disposed on the walls of the annulus.

Uniform flow rates (fuel, diluents, air, steam, etc.) would serve to reduce localized issues with regard to emissions, flame holding and temperature profiles.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. An apparatus for circumferential fluid distribution in an annulus coupleable with a feed supply pipe, the apparatus comprising:
a plurality of inlets arrayed in the annulus and receiving fluid from the feed supply pipe; and
a plurality of outlets connected to the annulus and delivering fluid radially inward from the annulus,
wherein the inlets distribute fluid in the annulus to the outlets, and wherein the inlets and the outlets are configured such that a fluid static pressure in the annulus is substantially consistent.

2. An apparatus according to claim 1, wherein the inlets are circumferentially offset relative to the feed supply pipe.

3. An apparatus according to claim 1, further comprising turbulators positioned around the annulus and axially along the annulus, the turbulators normalizing a mass flow rate such that a maximum flow rate among the plurality of outlets defines a substantially linear profile.

4. An apparatus according to claim 1, further comprising scoops positioned in the annulus adjacent the outlets facing either upstream or downstream of fluid flow.

5. An apparatus according to claim 4, wherein the scoops are placed preferentially in the annulus to control fluid flow.

6. An apparatus according to claim 4, wherein a depth or angle of the scoops varies to control fluid flow.

7. An apparatus according to claim 4, further comprising turbulators disposed in the annulus between respective scoops.

8. An apparatus for circumferential flow distribution in an annulus coupleable with a feed supply pipe, the apparatus comprising:
a plurality of inlets in the annulus and receiving flow from the feed supply pipe;
a plurality of outlets connected to the annulus and delivering the flow radially inward from the annulus,
wherein the inlets distribute fluid in the annulus to the outlets, and wherein the inlets are circumferentially offset relative to the feed supply pipe such that a static pressure circumferentially around the annulus is substantially consistent; and
scoops positioned in the annulus adjacent the outlets facing either upstream or downstream of fluid flow.

9. An apparatus according to claim 8, wherein the scoops are placed preferentially in the annulus to control flow.

10. An apparatus according to claim 8, wherein a depth or angle of the scoops varies to control flow.

11. An apparatus according to claim 8, further comprising turbulators disposed in the annulus between respective scoops.

12. A method for circumferential fluid distribution in an annulus including a plurality of inlets coupleable with a feed supply pipe and a plurality of outlets connected to the annulus and delivering fluid radially inward from the annulus, the method comprising:
configuring the inlets and the outlets such that a fluid static pressure circumferentially around the annulus is substantially consistent;
receiving fluid from the feed supply pipe; and
distributing the fluid to the outlets.

13. A method according to claim 12, wherein the configuring step is practiced by positioning the inlets circumferentially offset relative to the feed pipe.

14. A method according to claim 12, wherein the configuring step is practiced by positioning scoops in the annulus adjacent the outlets facing either upstream or downstream of fluid flow.

15. A method according to claim 12, further comprising normalizing a mass flow rate of the fluid such that a maximum flow rate among the plurality of outlets defines a substantially linear profile, the normalizing step being practiced by positioning turbulators around the annulus and axially along the annulus.
